(19) United States
(12) Patent Application Publication
(10) Pub. No.: US 2026/0312351 A1
(43) Pub. Date: Oct. 8, 2026

(54) SPLICED SPLIT MODULE FOR MODULAR CONNECTOR ASSEMBLY

(71) Applicant: Aptiv Technologies AG, Schaffhausen (CH)

(72) Inventors: Andreas URBANIAK, Münster (DE); Markus GAERTNER, Wuppertal (DE); Uvaraj GANESAN, Tamil Nadu (IN); Rajan KUMARESH, Tamil Nadu (IN); Benjamin SCHWARZ, Köln (DE)

(21) Appl. No.: 19/556,381

(22) Filed: Mar. 4, 2026

(30) Foreign Application Priority Data
Apr. 4, 2025 (EP) 25168543.4

(51) Int. Cl. H01R 31/08; H01R 13/405; H01R 13/66; H01R 43/24

(52) U.S. Cl. CPC H01R 31/08; H01R 13/405; H01R 13/6683; H01R 43/24

(57) ABSTRACT

A pin block module for a modular connector includes a pin block support with opposing connection surfaces and pins extending through the support, protruding from both surfaces. The module also includes at least one conductive splice element that electrically connects two or more of the pins together, enabling customized connectivity within the modular connector. The pin block module is designed for insertion into a housing of the modular connector, thereby providing a flexible and adaptable solution for various connection configurations.

### CROSS-REFERENCE TO RELATED APPLICATION

This application claims the benefit of and priority to European Application No. 25168543.4 filed with the European Patent Office on Apr. 4, 2025, the contents of which are incorporated by reference herein.

### TECHNICAL FIELD

The present disclosure relates to a pin block module for use in modular connectors. Specifically, the present disclosure pertains to a pin block module designed for insertion into a connector housing, featuring a pin block support with pins.

### BACKGROUND

In the field of modular connectors, it is common to use pin block modules for establishing electrical connections within a housing. These pin block modules typically involve multiple pins that extend through a support structure, allowing for connections on both sides of the module. Known systems often require the use of separate connectors and terminals to splice multiple pins together. This approach can be cumbersome and inefficient, as it necessitates additional components and assembly steps.

Previously, splicing pins when using a pin block module necessarily involved the use of external devices such as external splice savers or connectors, welded splices or crimped splices. These external devices are designed to connect multiple pins together, but they require separate terminals and additional wire lengths to achieve the desired connections. This not only increases the complexity of the assembly process but also adds to the overall size and weight of the connection. Furthermore, the additional wire lengths can introduce potential points of failure and reduce the reliability of the electrical connections.

Despite the substantial advances in the field of modular connectors, there remains a need for improved pin block modules that can provide reliable splicing of multiple pins without the drawbacks associated with separate connectors and additional wire lengths. The current methods of using external splice savers and terminals are not only inefficient but also prone to issues such as increased assembly time, higher manufacturing costs, and potential reliability concerns.

Therefore, a technical problem underlying the present invention is providing a pin block module that at least partially overcomes the disadvantages of known systems.

### SUMMARY

The present disclosure relates to a pin block module for use in modular connectors and to modular connectors incorporating such pin block modules.

In one aspect, a pin block module is provided for insertion into a housing of a modular connector. The pin block module includes a pin block support having a first connection surface and an opposing second connection surface, and at least two pins extending through the pin block support such that each pin protrudes from the first connection surface and from the second connection surface. The pin block module further includes at least one splice element that electrically connects the at least two pins to each other, thereby splicing the pins.

In some embodiments, the splice element is arranged inside the pin block support. In certain embodiments, the at least two pins and the splice element are integrally formed. The splice element may be configured such that the pins can be stitched into the pin block support without the splice element protruding from the pin block support.

In some embodiments, the pins include retention features for securing the pins within the pin block support. For example, the pins may include retention barbs arranged at an intermediate portion of the pins. In other embodiments, the pins include a retention contour formed by at least two splice portions of the splice element, the splice portions defining a through hole configured to improve retention of the pins when the pin block support is molded around the pins.

In further embodiments, the splice element is separate from the pins and is arranged inside the pin block support. The separate splice element may include a conductive trace that is part of a printed circuit board (PCB) arranged inside the pin block support. The conductive trace may directly connect at least two non-adjacent pins without electrically connecting one or more intermediate pins. In some embodiments, the PCB forms a central portion of the pin block support and is surrounded by an overmolded shell or by top and bottom covers held together by form-fit. The PCB may further include at least one sensor for monitoring operation of the pin block module, such as a temperature sensor or a moisture sensor.

In some embodiments, the pin block module includes at least three pins, wherein at least two of the pins are spliced by the splice element and at least one pin is not spliced.

In another aspect, a modular connector is provided that includes a connector housing having at least one pin block module seat and at least one pin block module mounted in the seat.

In a further aspect, methods of producing a pin block module are provided. In one method, a pin block support having pin holes according to a desired pattern is provided, and at least two pins are stitched into the pin block support. In another method, at least two pins are arranged according to a desired pattern and at least part of the pin block support is molded around the pins and the at least one splice element.

### BRIEF DESCRIPTION OF THE DRAWINGS

Other features, details, and advantages of the disclosure will become more apparent from the detailed illustrative description given hereafter with respect to the drawings in which:

FIG. 1 shows an isometric view of different types of pins arranged to be accommodated in a pin block support according to some embodiments.

FIG. 2 shows an isometric view of a pin block module with pins inserted into a pin block support according to some embodiments.

FIG. 3A shows a schematic diagram illustrating functioning of the integrated splice according to the prior art.

FIG. 3B shows a schematic diagram illustrating functioning of the integrated splice according to some embodiments.

FIGS. 4A and 4B show side views of a pin block module according to some embodiments.

FIGS. 5A and 5B show side views of a pin block module according to some other embodiments.

FIG. 6 shows an isometric view of a pin block module including separate splice elements according to some other embodiments.

FIG. 7 shows an isometric view of a pin block module shown in FIG. 6 with an outer protective shell according to some embodiments.

FIG. 8 shows a schematic diagram of a network according to the prior art.

FIG. 9 shows a schematic diagram of a network according to some embodiments.

### DETAILED DESCRIPTION

In the following, preferred embodiments of the present disclosure are described in detail with respect to the figures.

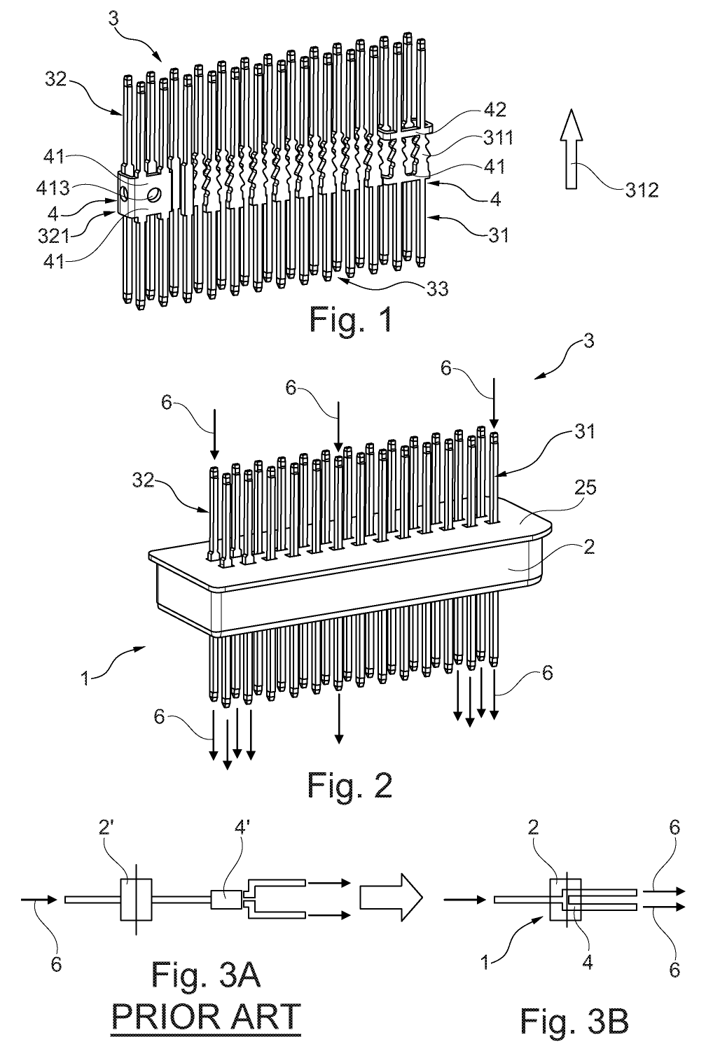

FIG. 1 illustrates a plurality of pins 3. The plurality of pins 3 includes an arrangement of four first pins 31 and four second pins 32 to be installed within a pin block support 2 (shown in FIG. 2). The first and second pins are spliced by means of splice elements 4, which will be described later in more detail. In addition, eighteen third pins 33 are arranged between the first and second pins. The third pins 33 are regular pins and not spliced. The pins 3 are arranged according to a desired pattern.

Retention barbs 311 are provided on the first pins 31, which facilitate anchoring within the pin block support 2. The retention barbs 311 are shaped to allow a direction of insertion 312 when stitching the first pins 31 into the pin block support 2. A splice element 4 in form of a splice portion 41 is integrally formed between the retention barbs 311 of two adjacent pins 31. The splice portions 41 are arranged at the ends of the respective retention barbs 311 when seen in the direction of insertion 312. Production tabs 42 are also present on these first pins 31 at the beginning of the retention barbs 311 when seen in the direction of insertion 312. These production tabs 42, however, are intended to be removed prior to the stitching of the first pins 31 into the pin block support 2. In the arrangement of the first pins 31, four pins are connected by three splice portions 41.

The second pins 32 are spliced by means of a splice element 4 that is formed by upper and lower splice portions 41 arranged in the center of the second pins 32. The splice element also forms a retention contour 321 of adjacent second pins 32. Together, the splice portions 41 define a through hole 413, designed to improve the retention of the second pins 32 upon e.g., molding the pin block support 2 onto (around) the pins. Also, in the shown arrangement of the second pins 32, four pins 32 are spliced (i.e., connected with each other) in a rectangular configuration.

FIG. 2 provides a detailed view of a pin block module 1, including a pin block support 2 and the plurality of pins 3 of FIG. 1 arranged therein. On the left side, the pin block support 2 is overmolded onto the second pins 32. On the right side, the first pins 31 and third pins 33 are stitched into the pin block support 2 (obviously, the stitching is done after the support is molded onto the second pins). The pin block support 2 is shown as a solid structure, with pins extending from both the top surface 24 and the bottom surface (not visible in FIG. 2). The top surface is in the following denoted as first connection surface 24 and the bottom surface is denoted as the opposing second connection surface 25. Arrows indicate a possible direction of electricity/signal flow 6 (input/output) of the pins 3. As the second pins 32 are spliced in a rectangular configuration, a single signal input into one pin is split into four signal outputs. Thus, the other three pin ends protruding from the first connection surface 24 of four spliced pins 32 are essentially without function and could be cut off. However, it is more cost efficient to simply leave the same. Similarly, the four first pins 31 are being spliced amongst them. Thus, a signal flow 6 input introduced into one pin leads to four signal flow 6 outputs, as indicated by the arrows. With the regular, un-spliced pins 33, each signal flow 6 input results in a single signal flow 6 output of the same pin.

FIGS. 3A and 3B schematically illustrate the flow of electricity through a pin block support 2, 2’ and a splice element 4, 4’. FIG. 3A show the prior art in which the electricity (signal) flow 6 is depicted as first passing through a pin block support 2’ and after that through a separate splice element 4’ not part of the pin block support 2’. FIG. 3B shows an embodiment of a pin block module 1 a with the pin block support 2 and the splice element 4 both being part of the pin block module 1.

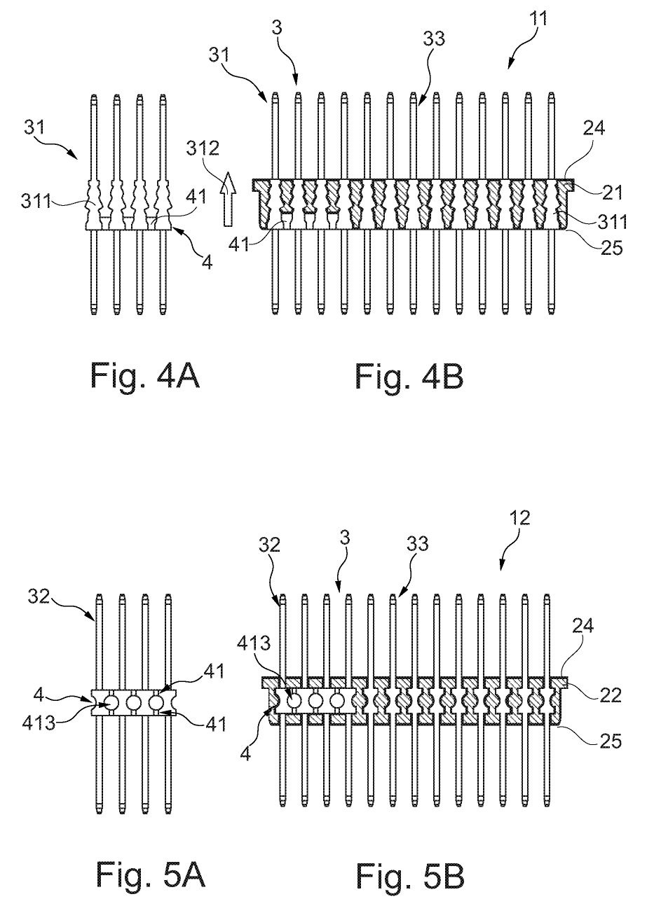

FIGS. 4A and 4B show an embodiment of another pin block module 11 including a plurality (one row of 13 pins in total) of pins 3. The pin block module 11 includes a pin block support 21, which has a first connection surface 24 and an opposing second connection surface 25. Pin block module 11 includes four spliced pins 31, which extend through the pin block support 21. Thus, one signal introduced to one of the four spliced pins is split into four signals. Each pin 31 protrudes from both the first connection surface 24 and the second connection surface 25. The pins 31 are stitched into the pin block support 21 in the direction indicated by arrow 312. The pins 31 include retention barbs 311 at their center, which anchor the pins 31 within the pin block support 21. The module further includes a splice element 4 with splice portions 41, which connects the four pins 31 with each other. The splice element 4 is arranged completely inside the pin block support 21 and is integrally formed with the pins 31. Generally, the splice element 4 is formed such that the pins 31 can be stitched into the pin block support 21 without the splice element 4 protruding from the pin block support 21. The splice portions 41 are arranged at the end of the barbs 311 when seen in the direction of insertion 312, allowing the length of the barbs 311 to anchor within the pin block support 21 upon stitching. In the module 11 of FIGS. 4A and 4B, also nine regular pins 33 are visible, that are not spliced.

FIGS. 5A and 5B illustrate another embodiment of a pin block module 12, similar to the module 11 of FIGS. 4A and 4B. This pin block module 12 includes a pin block support 22, which holds in total thirteen pins 3, of which four pins 32 are spliced with each other, and nine pins 33 are not spliced. The pin block module 22 is overmolded over all of the pins 3. The module 12 includes a splice element 4, which connects the spliced pins 32 to each other. The splice element 4 is arranged inside the pin block support 22 and includes splice portions 41 that define a through hole 413. The through hole 413 increases the retention force of the spliced pins 32 upon molding. The splice element 4is integrally formed with the spliced pins 32.

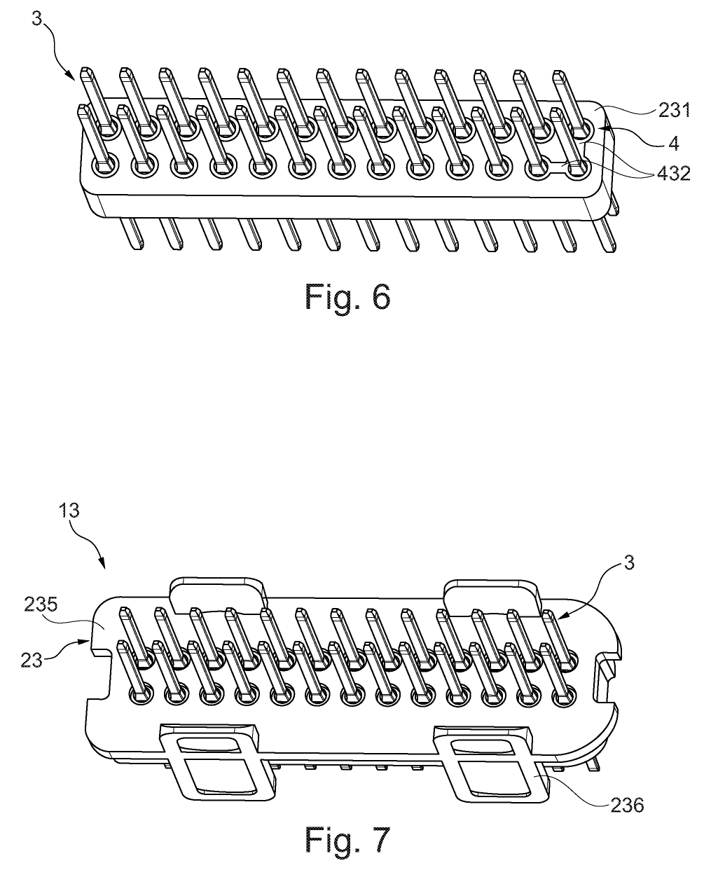

FIG. 6 shows a printed circuit board (PCB) 231, that can be arranged inside a pin block support 23 (shown in FIG. 7). A plurality of pins 3 (26 pins in total) is stitched through the PCB 231. The pins 3 may be regular pins 33 as also shown in FIG. 1. The PCB 231 features conductive traces 432 that serve as a splice element 4 to electrically connect (splice) pins 3. In the shown example, the traces 432 connect three pins 3 in a triangular configuration.

FIG. 7 illustrates a pin block module 13 including a pin block support 23 that encapsulates the PCB 231 of FIG. 6. To this end, the pin block support 23 includes an overmolded shell 235 surrounding the PCB 231. The overmolded shell 235 forms the exterior of the pin block support 23, providing structural integrity and protection to the internal components. The pins 3 protrude through the overmolded shell 235, allowing for external connections. The pin block module 13 also includes structural features such as mounting elements 236, which facilitate the installation of the module into a housing.

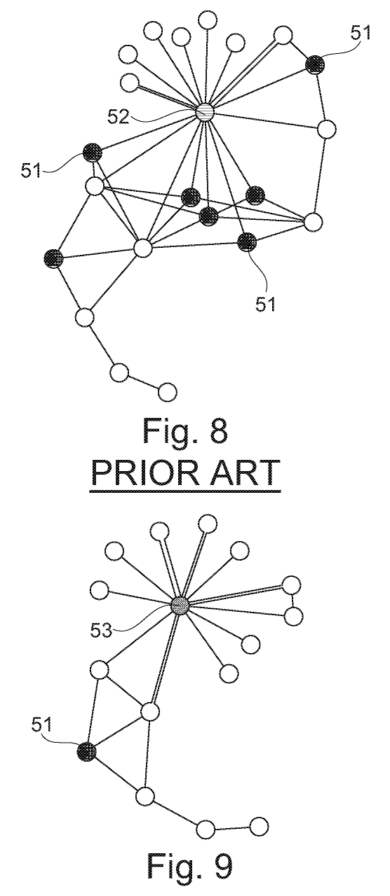

FIG. 8 shows a prior art configuration of a network with multiple splices 51. The network is composed of nodes interconnected by lines representing connections including one or more wires between the two endpoints, where each node represents a possible wire endpoint such as for example a connector, a splice, a splice saver or a ring terminal. The splices 51 are distributed throughout the network, indicating points where splicing occurs. The splices are positioned at various nodes, suggesting that splicing is required at multiple locations within the network. The figure illustrates a complex arrangement with several splices, which may imply potential inefficiencies or vulnerabilities and manufacturing hurdles in the network due to the numerous splicing points.

FIG. 9 illustrates an embodiment, which allows an improved network configuration. In this figure, the network also consists of nodes interconnected by lines, similar to the prior art network of FIG. 8. However, the invention introduces an integrated splice saver 53, such as a pin block module 1 of the invention. This integrated splice saver 53 is strategically placed within the network, reducing the number of splices 51 required. The figure shows that the integrated splice saver 53 consolidates multiple splicing points into a single location, thereby simplifying the network structure. The reduction in the number of splices 51 enhances the network's efficiency and reliability by minimizing the potential points of failure and maintenance requirements and facilitating manufacturing. This configuration demonstrates a significant improvement over the prior art by optimizing the splicing process and reducing the complexity of the network.

While the invention has been described with reference to an exemplary embodiment(s), it may be understood by those skilled in the art that various changes may be made, and equivalents may be substituted for elements thereof without departing from the scope of the invention. In addition, many modifications may be made to configure a particular situation or material to the teachings of the invention without departing from the essential scope thereof. Therefore, it is intended that the invention is not limited to the disclosed embodiment(s), but that the invention will include all embodiments falling within the scope of the appended claims.

As used herein, ‘one or more’ includes a function being performed by one element, a function being performed by more than one element, e.g., in a distributed fashion, several functions being performed by one element, several functions being performed by several elements, or any combination of the above.

It may also be understood that, although the terms first, second, etc., are, in some instances, used herein to describe various elements, these elements should not be limited by these terms. These terms are only used to distinguish one element from another. For example, a first contact could be termed a second contact, and, similarly, a second contact could be termed a first contact, without departing from the scope of the various described embodiments. The first contact and the second contact are both contacts, but they are not the same contact.

The terminology used in the description of the various described embodiments herein is for the purpose of describing particular embodiments only and is not intended to be limiting. As used in the description of the various described embodiments and the appended claims, the singular forms “a”, “an”, and “the” are intended to include the plural forms as well, unless the context clearly indicates otherwise. It may also be understood that the term “and/or” as used herein refers to and encompasses any and all possible combinations of one or more of the associated listed items. It may be further understood that the terms “includes,” “including,” “comprises,” and/or “comprising,” when used in this specification, specify the presence of stated features, integers, steps, operations, elements, and/or components, but do not preclude the presence or addition of one or more other features, integers, steps, operations, elements, components, and/or groups thereof.

As used herein, the term “if” is, optionally, construed to mean “when” or “upon” or “in response to determining” or “in response to detecting,” depending on the context. Similarly, the phrase “if it is determined” or “if [a stated condition or event] is detected” is, optionally, construed to mean “upon determining” or “in response to determining” or “upon detecting [the stated condition or event]” or “in response to detecting [the stated condition or event],” depending on the context.

Additionally, while terms of ordinance or orientation may be used herein these elements should not be limited by these terms. All terms of ordinance or orientation, unless stated otherwise, are used for purposes distinguishing one element from another, and do not denote any particular order, order of operations, direction or orientation unless stated otherwise.

### LIST OF REFERENCE SIGNS

1, 11, 12, 13 pin block modules
2, 21, 22, 23 pin block support
2’ prior art pin block support
3 pins
4, 4’ splice elements
6 electricity/signal flow (input/output)
24 first connection surface
25 second connection surface
31 first pins
32 second pins
33 third pins / regular pins
41 splice portions
42 production tabs
51 splice
52 connector of the prior art
53 integrated splice saver
231 PCB
235 shell
236 mounting elements
311 retention barbs
312 direction of insertion
321 retention contour
432 conductive trace

1. A pin block module for insertion into a housing of a modular connector, the pin block module comprising:
a pin block support having a first connection surface and an opposing second connection surface;
at least two pins extending through the pin block support such that each pin protrudes from the first connection surface and from the second connection surface; and
at least one conductive splice element, wherein the splice element electrically connects two or more of the pins together.

2. The pin block module according to claim 1, wherein the at least one splice element is arranged inside the pin block support.

3. The pin block module according to claim 1, wherein the at least two pins and the splice element are integrally formed and arranged inside the pin block support.

4. The pin block module according to claim 1, wherein the splice element is formed such that the at least two pins can be stitched into the pin block support.

5. The pin block module according to claim 1, wherein the pins comprise retention barbs in an intermediate portion of the pins to anchor the pins within the pin block support.

6. The pin block module according to claim 1, wherein the pins include a retention contour at a center of the pins and wherein the splice element comprises at least two splice portions, the splice portions defining a through hole.

7. The pin block module according to claim 1, wherein at least one splice element is a splice element physically distinct from and not integrally formed with the pins and arranged inside the pin block support.

8. The pin block module according to claim 7, wherein the separate splice element comprises a conductive trace which is part of a printed circuit board (PCB) arranged inside the pin block support.

9. The pin block module according to claim 8, wherein the conductive trace of the separate splice element directly connects at least two non-adjacent pins without connecting intermediate pin(s) between the two pins which are non-adjacent along a row of pins.

10. The pin block module according to claim 8, wherein the PCB forms a center of the pin block support and wherein the pin block support further comprises an overmolded shell, or top and bottom covers held together by form-fit and surrounding the PCB.

11. The pin block module according to claim 8, wherein the PCB comprises at least one sensor for monitoring temperature or moisture conditions of the pin block module.

12. The pin block module according to claim 11, wherein the PCB comprises a temperature sensor.

13. The pin block module according to claim 1, wherein the pin block comprises at least three pins, wherein at least two pins are spliced and wherein at least one pin is not electrically connected to the spliced pins.

14. A modular connector, comprising:
a connector housing with at least one pin block module seat; and
at least one pin block module according to claim 1 mounted in the at least one seat.

15. A method of producing a pin block module having a pin block support having a first connection surface and an opposing second connection surface, at least two pins extending through the pin block support such that each pin protrudes from the first connection surface and from the second connection surface, and at least one splice element connecting the at least two pins to each other to splice them, the method comprising:
providing a pin block support with pin holes according to a desired pattern; and
stitching at least two pins into the pin block support.

16. A method of producing a pin block module having a pin block support having a first connection surface and an opposing second connection surface, at least two pins extending through the pin block support such that each pin protrudes from the first connection surface and from the second connection surface, and at least one splice element connecting the at least two pins to each other to splice them, the method comprising:
arranging at least two pins according to a desired pattern; and
molding at least part of the pin block support around the at least two pins and the at least one splice element.
